(19) United States
(12) Patent Application Publication
(10) Pub. No.: US 2015/0209872 A1
(43) Pub. Date: Jul. 30, 2015

(54) ELASTIC CHUCK

(71) Applicant: HURISE CO., LTD., Taichung City (TW)

(72) Inventors: Jung-Feng CHANG, Taichung City (TW); Jung-Sheng CHANG, Taichung City (TW)

(21) Appl. No.: 14/594,929

(22) Filed: Jan. 12, 2015

(30) Foreign Application Priority Data
Jan. 29, 2014 (TW) 103103570

(51) Int. Cl. B23B 31/32

(52) U.S. Cl. CPC B23B 31/32

(57) ABSTRACT

An elastic chuck includes a base plate, an elastic plate and jaws. The base plate has a through hole running between upper and lower surfaces thereof. The elastic plate has a fixing ring fixed to the base plate, a pulling block that can move along a central axis of the through hole, and holders radially extending from the pulling block toward the fixing ring. Each of the holders has a top surface facing the upper surface of the base plate across a radial gap. The jaws are mounted at top surfaces of the holders, respectively. The pulling block of the elastic plate receives a pulling force along the central axis to drive the jaws to hold a workpiece firmly. The elastic chuck has a simple structure and limited parts, so its process of manufacturing and assembling are time-saving and cost saving, and the resultant structure is highly precise.

### BACKGROUND OF THE INVENTION

1. Technical Field

The present invention relates to a clamping device, and more particularly to an elastic chuck.

2. Description of Related Art

As described in Taiwan Patent No. M359385, a known chuck comprises a base plate that is fixed to a machine and centrally formed with a through hole and a plurality of jaw units installed on the base plate. The chuck typically has three or four jaw units, each of which comprises a sliding block slidably attached to the surface of the base plate, a jaw movably fixed to the sliding block, and a rotary member deposited inside the base plate. The rotary members of the jaw units are driven to rotate a shaft that is located in the through hole. When the shaft is driven by the machine, it moves axially to drive the sliding blocks to move, thereby making the jaws come close to each other and hold a workpiece firmly.

Many conventional chucks are similar configured with the shaft driving the rotary members, the sliding blocks, and in turn the jaws. However, such configuration is structurally complicated and needs numerous parts, so its manufacturing and assembling are time-consuming and costly, and the resultant structure tends to be less precise due to errors happening during the process of manufacturing and assembling.

### SUMMARY OF THE INVENTION

In view of this, an objective of the present invention is to provide an elastic chuck that has a simple structure and limited parts, so its process of manufacturing and assembling are time-saving and cost saving, and the resultant structure is highly precise.

To achieve the foregoing objective, a disclosed elastic chuck in this present invention comprises a base plate, an elastic plate, and a plurality of jaws. The base plate has an upper surface, a lower surface, and a through hole running therebetween. A central axis is defined by the through hole. The elastic plate is integratedly formed as an unity and has a fixing ring, a pulling block located at the center of the fixing ring, and a plurality of holders radially extending from the pulling block toward the fixing ring. The fixing ring is fixed to the base plate. The pulling block can receive a pulling force and be movably mounted substantially along the central axis inside the through hole. Each of the holders has a bottom surface and a top surface. The bottom surface faces the upper surface of the base plate, and there is a radial gap between the bottom surface and the upper surface. Each of the jaws is mounted at the top surface of the holders.

The pulling block of the elastic plate can be connected to a shaft. When the shaft is pulled by a force-applying device, it drives the pulling block of the elastic plate, so that the holders perform elastic deformation and become inclined toward the through hole, thereby driving the jaws to come close to each other and firmly hold a workpiece. As compared to the conventional devices, the disclosed elastic chuck has a simple structure and limited parts, so its process of manufacturing and assembling are time-saving and cost saving, and the resultant structure is highly precise.

The invention as well as a preferred mode of uses, further objectives and advantages thereof will be best understood by reference to the following detailed description of embodiments when read in conjunction with the accompanying drawings. However, people having ordinary skill in the art should understand that the description and particular embodiments for implementing the present invention are illustrative and by no means intended to limit the scope of clams in the present invention.

### BRIEF DESCRIPTION OF THE DRAWINGS

FIG. 1 is a perspective view of an elastic chuck of one preferred embodiment of the present invention assembled with a shaft;

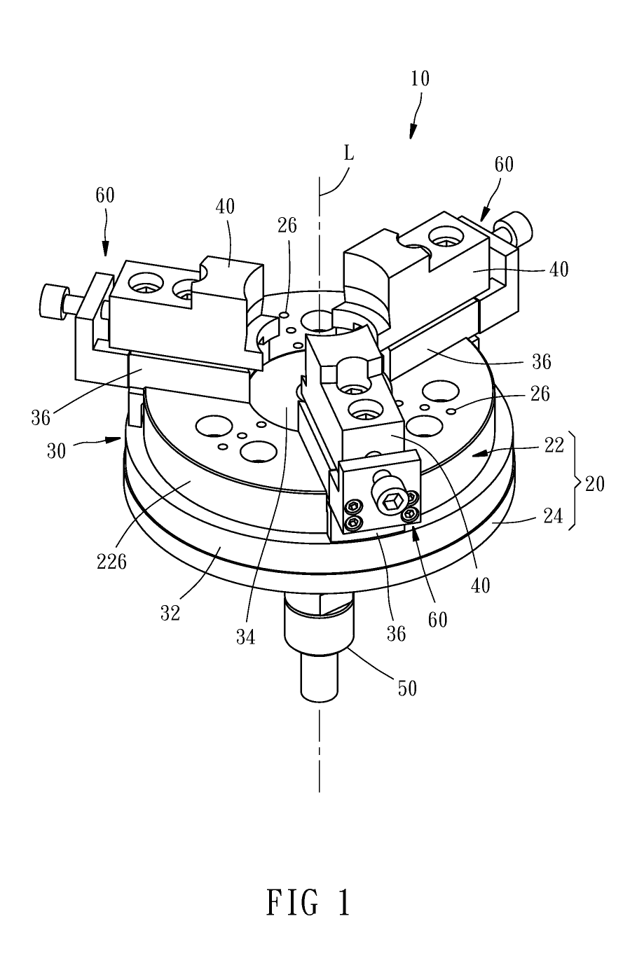

FIG. 2 is an exploded view of the elastic chuck and the shaft of one preferred embodiment of the present invention;

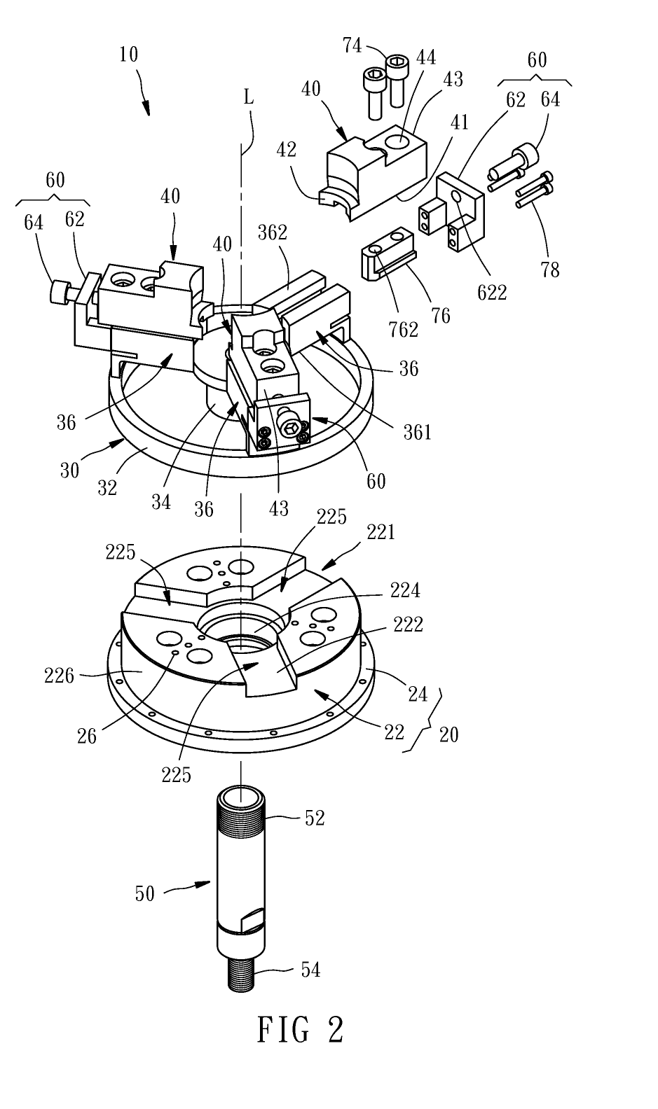

FIG. 3 is a perspective view of an elastic plate of the elastic chuck of one preferred embodiment of the present invention;

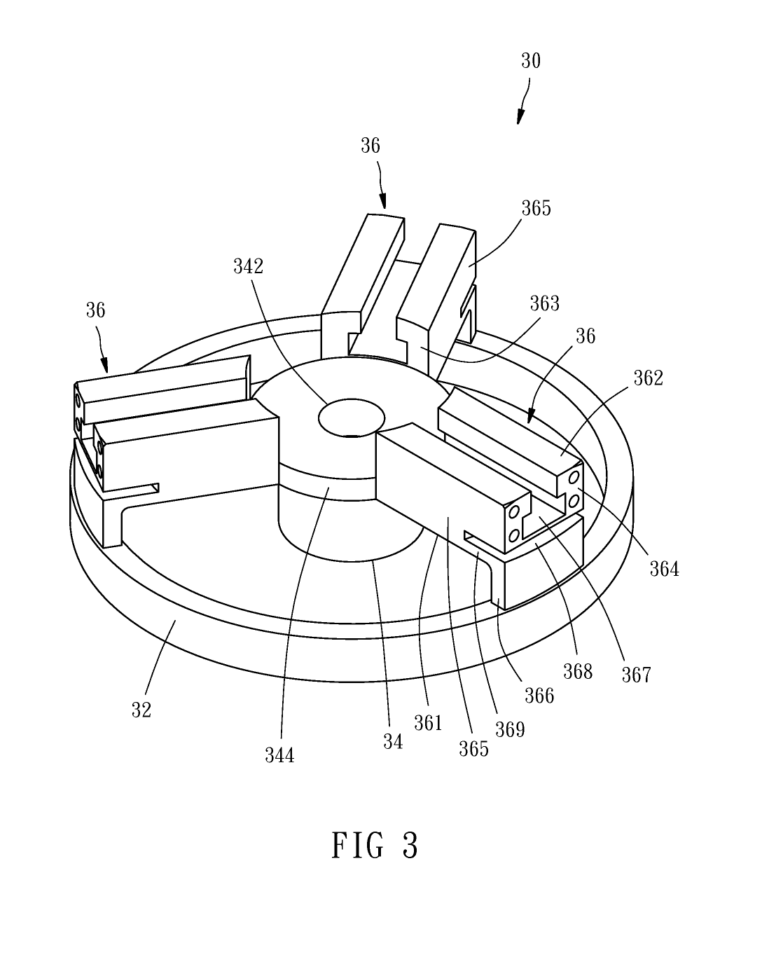

FIG. 4 is a top view of the elastic chuck of one preferred embodiment of the present invention; and

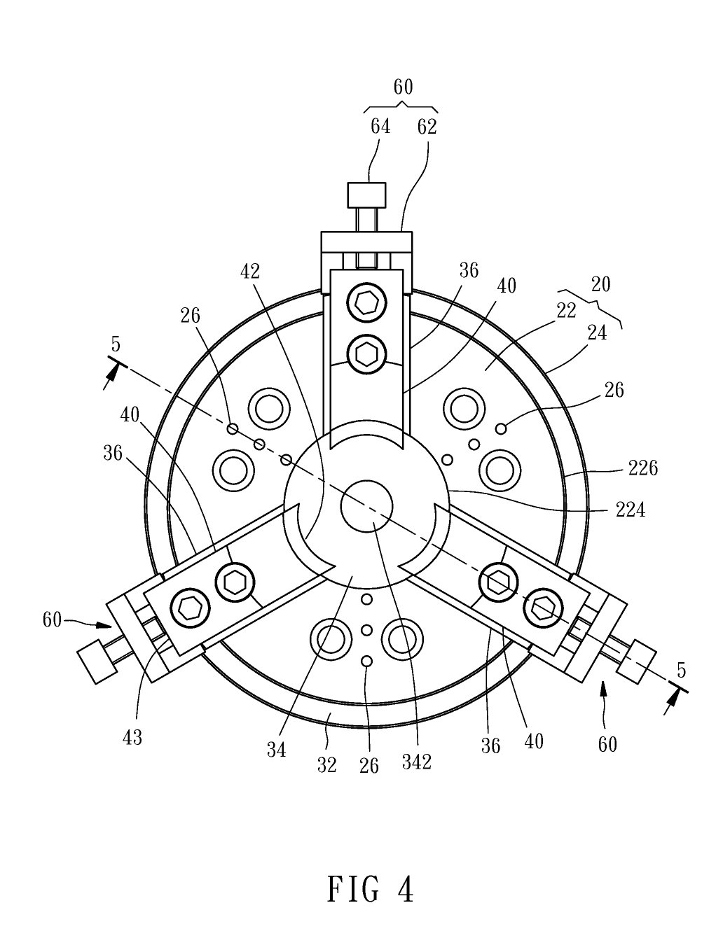

FIG. 5 is a cross-sectional view of the elastic chuck taken along Line 5-5 of FIG. 4, wherein the shaft connected to the elastic chuck is shown.

### DETAILED DESCRIPTION OF THE INVENTION

Referring to the accompanying drawings, according to one preferred embodiment of the present invention, an elastic chuck 10 comprises a base plate 20, an elastic plate 30, three jaws 40, and three retaining units 60. The elastic chuck 10 is connected to a shaft 50 such that it can receive the pulling force from the shaft 50 to hold a workpiece firmly (not shown).

The base plate 20 has a disk-like main body 22 and an annular flange 24. The main body 22 has a radial depressed portion 221, an upper surface 222 in the depressed portion 221, a lower surface 223 reverse to the upper surface 222, and a through hole 224 running between the upper surface 222 and the lower surface 223. An imaginary central axis L is defined by the through hole. The depressed portion 221 is communicated with the through hole 224 and has three accommodating sections 225 radially distributed around the through hole 224. The flange 24 is integratedly raised from the outer peripheral surface 226 of the main body 22.

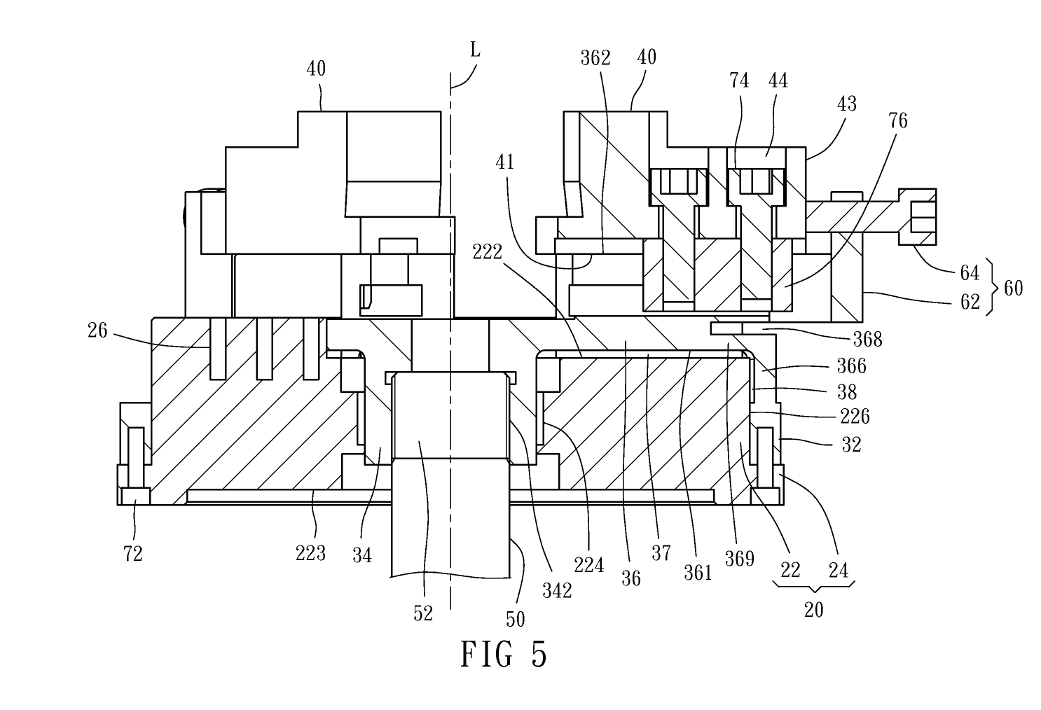

The elastic plate 30 is integratedly formed as a unity and has an annular fixing ring 32, a pulling block 34 located at the center of the fixing ring 32, and three holders 36 radially extending from the pulling block 34 toward the fixing ring 32. The fixing ring 32 is mounted around the main body 22 of the base plate 20, and is fixed to the flange 24 by means of screws 72. The pulling block 34 is deposited in the through hole 224 of the base plate 20 and has a through hole 342 that is partially formed with threads. The central axis L passes through the through hole 342. The holders 36 are installed in the accommodating sections 225, respectively. Each of the holders 36 has a bottom surface 361 and a top surface 362 reverse to each other, an inner end surface 363 facing the central axis L and connected to the outer peripheral surface 344 of the pulling block 34, an outer end surface 364 reverse to the inner end surface 363, and two lateral surfaces 365 connected between the inner end surface 363 and the outer end surface 364. The bottom surface 361 extends outward an axial connecting rib 366 that is connected to the fixing ring 32. Each of the holders 36 further comprises a groove 367 open to its top surface 362 and inner and outer end surfaces 363, 364, and a slit 368 open to the outer end surface 364 and the two lateral surface 365. Between the slit 368 and the bottom surface 361 of each of the holders 36 there is a radial connecting rib 369 that is connected to the axial connecting rib 366. As shown in FIG. 5, the bottom surface 361 of each of the holders 36 faces the upper surface 222 of the base plate 20 with a radial gap 37 left therebetween, and the axial connecting rib 366 of each of the holders 36 faces the outer peripheral surface 226 of the main body 22 of the base plate 20 with an axial gap 38 left therebetween.

The jaws 40 are mounted at the top surfaces 362 of the holders 36 respectively. Each of the jaws 40 has a connecting surface 41 for connecting the top surface 362 of the corresponding holder 36, a clamping surface 42 facing the central axis L, and a retaining surface 43 reverse to the clamping surface 42. In the present embodiment, each of the jaws 40 is installed on the holder 36 in a positionally adjustable manner by means of two screws 74 and an adjusting block 76. The adjusting block 76 is installed into the groove 367 of the holder 36 from the opening of the holder 36 at the outer end surface 364 and is allowed to slide inside the groove 367. The two screws 74 are screwed into two counterbores 44 formed on the jaw 40 and engaged with two threaded holes 762 of the adjusting block 76, thereby fixing the position of the jaw 40 and the adjusting block 76 with respect to the holder 36.

The shaft 50 has a connecting portion 52 and a force-receiving portion 54 that are located at two ends thereof and both of them have threads. The connecting portion 52 is screwed to the through hole 342 of the pulling block 34 of the elastic plate 30, and the force-receiving portion 54 is screwed to a force-applying device (not shown), for receiving a pulling force substantially along the central axis L applied by the force-applying device. Thereby, when the pulling force is applied to the shaft 50, the shaft 50 brings the elastic plate 30 to move substantially along the central axis L (moving downward in FIG. 5), so that the holders 36 perform elastic deformation and become inclined toward the through hole 224, thereby drawing the jaws 40 together to jointly hold a workpiece (not shown) positioned among the jaws 40. The elastic chuck 10 can further use plural jig-receiving holes 26 and screws (not shown) on the base plate 20 to have jigs (not shown) attached thereto. In this manner, different jigs can be selectively used to assist the holding of different workpieces.

Each of the retaining units 60 has a fixing seat 62 and a propping member 64 that can be driven by an external force to move within the fixing seat 62. In the present embodiment, the fixing seat 62 has an adjusting hole 622 that is a threaded hole, and the propping member 64 is a bolt mounted in the adjusting hole 622, so that by rotating the propping member 64, the propping member 64 can move linearly with respect to the fixing seat 62. The fixing seats 62 of the retaining units 60 are fixed to outer end surface 364 of the holders 36 by means of screws 78, and the propping members 64 of the retaining units 60 prop against the retaining surfaces 43 of the jaws 40, respectively.

In the present embodiment, the top surface 362 of each of the holders 36 of the elastic plate 30 is a smooth and flat surface, and the connecting surface 41 of each of the jaws 40 for connecting with the top surface 362 of the holder 36 of the elastic plate 30 is also a smooth surface. As compared to the conventional device wherein the jaws and the holders are engaged with toothed surfaces, the cooperation between the smooth surfaces of the jaw 40 and the holder 36 as proposed in the present invention better allows fine adjustment of the relative position between the jaw 40 and the holder 36. The retaining units 60 serve to prevent the jaws 40 from sliding on the top surfaces 362 of the holders 36 due to counterforce from the workpiece. Alternatively, the elastic chuck 10 may eliminates the use of the retaining units 60. In other embodiments, either of the top surface 362 of the holder 36 and the connecting surface 41 of the jaw 40 is a rough surface (such as a toothed surface), so as to increase friction between the jaw 40 and the holder 36, thereby also preventing the jaws 40 from sliding on the top surfaces 362 of the holders 36 due to counterforce from the workpiece.

The disclosed elastic chuck 10 features that the elastic plate 30 is integratedly formed as a unity and has the holders 36 that can perform elastic deformation, so there is no need to use numerous parts to interact and drive the jaws 40. Instead, only the elastic plate 30 driven by the shaft 50 is enough to drive the jaws 40. Therefore, as compared to the conventional elastic chucks, the disclosed elastic chuck 10 of the present invention has a simple structure and limited parts, so its process of manufacturing and assembling are time-saving and cost saving, and the resultant structure is highly precise

It is to be noted that each of the holders 36 of the elastic plate 30 has the axial connecting rib 366, the slit 368 and the radial connecting rib 369. All these are to enhance the capacity of elastic deformation of the holder 36. However, the holder 36 is not limited to having the axial connecting rib 366, the slit 368 and the radial connecting rib 369. As long as the radial gap 37 exists between the bottom surface 361 of the holder 36 and the upper surface 222 of the base plate 20, the holder 36 is allowed to incline toward the through hole 224. The axial gap 38 may be formed between the axial connecting rib 366 of the holder 36 and the outer peripheral surface 226 of the base plate 20, so that the axial connecting rib 366 is allowed to incline toward the outer peripheral surface 226. The base plate 20 may be shaped differently and connected to the elastic plate 30 in different ways from those described in the present embodiment, as long as the fixing ring 32 is well fixed to the base plate 20 (such as by means of screws screwed to the outer peripheral surface 226) and the pulling block 34 is allowed to move substantially along the central axis L inside the through hole 224, and the bottom surfaces 361 of the holders 36 face the upper surface 222 of the base plate 20.

While in the present embodiment the elastic chuck 10 having three said jaws 40 is described to explain the configuration of the disclosed elastic chuck, the elastic plate 30 may have different numbers of the jaws 40 as long as the numbers of the holders 36 and of the retaining units 60 are consistent with each other. In other embodiments of the present invention, the elastic chuck 10 may have two, four or more said jaws 40, and the holders 36 of the elastic plate 30 and the retaining units 60 in corresponding numbers.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the claims in this application.

What is claimed is:

1. An elastic chuck, comprising:
a base plate, having an upper surface, a lower surface, and a through hole running between the upper surface and the lower surface, a central axis defined by the through hole;
an elastic plate, being integratedly formed as a unity and having a fixing ring, a pulling block located at the center of the fixing ring, and a plurality of holders radially extending from the pulling block toward the fixing ring, the fixing ring being fixed to the base plate, the pulling block being for receiving a pulling force and movably mounted substantially along the central axis within the through hole, each said holder having a bottom surface and a top surface, the bottom surface facing the upper surface of the base plate, and a radial gap existing between the bottom surface and the upper surface; and
a plurality of jaws, each one being mounted on the top surface of the holders respectively.

2. The elastic chuck of claim 1, wherein each of the holders has an axial connecting rib that extends outward from the bottom surface thereof and is connected to the fixing ring.

3. The elastic chuck of claim 2, wherein the base plate has an outer peripheral surface, and the axial connecting rib of each of the holders faces the outer peripheral surface of the base plate, in which an axial gap exists between each of the axial connecting ribs and the outer peripheral surface.

4. The elastic chuck of claim 2, wherein each of the holders has an inner end surface facing the central axis, an outer end surface reverse to the inner end surface, two lateral surfaces connected between the inner end surface and the outer end surface, and a slit open to the outer end surface and the two lateral surfaces, in which a radial connecting rib is formed between the slit of each of the holders and the bottom surface and connected to the axial connecting rib.

5. The elastic chuck of claim 1, wherein each of the holders has an inner end surface facing the central axis, an outer end surface reverse to the inner end surface, two lateral surfaces connected between the inner end surface and the outer end surface, and a slit open to the outer end surface and the two lateral surfaces.

6. The elastic chuck of claim 1, wherein the base plate includes a main body and a flange, the main body having an outer peripheral surface, the flange being raised from the outer peripheral surface, and the fixing ring of the elastic plate being mounted around the main body and fixed to the flange.

7. The elastic chuck of claim 1, wherein the base plate has a depressed portion that is communicated with the through hole and has a plurality of accommodating sections that are radially distributed around the through hole, in which the upper surface of the base plate is located in the depressed portion, and the holders of the elastic plate each located in one said accommodating section.

8. The elastic chuck of claim 1, wherein the top surface of each said holder has a flat and smooth surface.

9. The elastic chuck of claim 8, wherein each of the jaws has a connecting surface for connecting the top surface of the corresponding holder and the connecting surface is a flat and smooth surface.

10. The elastic chuck of claim 1, wherein each of the jaws has a connecting surface for connecting the top surface of the corresponding holder and the connecting surface is a flat and smooth surface.

11. The elastic chuck of claim 1, further comprising a plurality of retaining units, each of the retaining units comprises a fixing seat and a propping member that is movably installed in the fixing seat and to be moved by an external force, the fixing seats of the retaining units being fixed to the holders, each of the jaws having a clamping surface facing the central axis and a retaining surface reverse to the clamping surface, and the propping members of the retaining units propping against the retaining surfaces of the jaws respectively.
